(19) United States
(12) Patent Application Publication
(10) Pub. No.: US 2026/0252762 A1
(43) Pub. Date: Aug. 27, 2026

(54) WIND TURBINE TOWER STRUCTURE OPTIMIZATION METHOD BASED ON FINITE ELEMENT ANALYSIS

(71) Applicants: HUANENG SHAANXI DINGBIAN ELECTRIC POWER CO., LTD., YULIN (CN); HUANENG DINGBIAN NEW ENERGY POWER GENERATION CO., LTD., YULIN (CN)

(72) Inventors: CHAO GUO, YULIN (CN); JUN LIU, YULIN (CN); XIN XIE, YULIN (CN); JINLU HU, YULIN (CN); XIAOJUN HUANG, YULIN (CN); ZHEN LU, YULIN (CN); KUN GAO, YULIN (CN)

(73) Assignees: HUANENG SHAANXI DINGBIAN ELECTRIC POWER CO., LTD., YULIN (CN); HUANENG DINGBIAN NEW ENERGY POWER GENERATION CO., LTD., YULIN (CN)

(21) Appl. No.: 19/538,339

(22) Filed: Feb. 12, 2026

(30) Foreign Application Priority Data
Feb. 21, 2025 (CN) 202510198936.8

(51) Int. Cl. G06F 30/23; F03D 7/02; F03D 7/04; F03D 17/00

(52) U.S. Cl. CPC G06F 30/23; F03D 7/0292; F03D 7/048; F03D 17/00

(57) ABSTRACT

Provided is a wind turbine tower structure optimization method based on finite element analysis, including: acquiring design requirements of a target wind turbine tower, and establishing a three-dimensional finite element model of the target wind turbine tower; identifying fatigue-prone areas by performing linear stress analysis on the three-dimensional finite element model through finite element software; generating a first model by adjusting prestressed structural parameters of the three-dimensional finite element model and performing iterative optimization until the fatigue-prone areas meet targets of fatigue resistance and safety; using a fatigue analysis method to predict performance of the first model during a preset service life to obtain a prediction result; and performing inverse optimization on the first model according to the prediction result and adjusting model parameters of the first model to generate an optimal model. The tower structure is optimized, the tower strength is improved, and the cost is reduced.

### CROSS-REFERENCE TO RELATED APPLICATIONS

This disclosure claims priority of Chinese Patent Application No. 202510198936.8, filed on Feb. 21, 2025, the contents of which are hereby incorporated by reference.

### TECHNICAL FIELD

The present disclosure relates to the field of structure optimization technologies, and in particular, to a wind turbine tower structure optimization method based on finite element analysis.

### BACKGROUND

With the continuous increase in global demand for renewable energy, wind energy, as a clean and renewable energy form, has attracted widespread attention. However, existing wind power generation towers face many challenges in terms of structural safety, maintenance costs and land occupation; traditional wind power generation towers mostly adopt conventional steel structures, which have problems such as insufficient fatigue resistance, high maintenance costs, and large land occupation. At the same time, the collector line box-type transformer is independently arranged on the ground, requiring additional land acquisition and foundation construction, which increases the construction cost.

Therefore, the present disclosure proposes a wind turbine tower structure optimization method based on finite element analysis.

### SUMMARY

The present disclosure provides a wind turbine tower structure optimization method based on finite element analysis, which is used to establish a three-dimensional finite element model of a wind turbine tower, perform linear stress analysis to identify fatigue-prone areas, adjust prestressed structural parameters for iterative optimization to ensure that the fatigue areas meet safety requirements, generate a preliminary model, perform fatigue analysis to predict the performance of the model during a service life, and perform inverse optimization according to a prediction result to adjust the parameters of the model, thereby finally obtaining an optimal wind turbine tower design, which effectively improves the fatigue durability and structural safety of the tower.

On one aspect, the present disclosure provides a wind turbine tower structure optimization method based on finite element analysis, including:
Step 1: acquiring design requirements of a target wind turbine tower, and establishing a three-dimensional finite element model of the target wind turbine tower;
Step 2: identifying fatigue-prone areas by performing linear stress analysis on the three-dimensional finite element model through finite element software;
Step 3: generating a first model by adjusting prestressed structural parameters of the three-dimensional finite element model and performing iterative optimization until the fatigue-prone areas meet targets of fatigue resistance and safety;
Step 4: using a fatigue analysis method to predict performance of the first model during a preset service life to obtain a prediction result; and
Step 5: performing inverse optimization on the first model according to the prediction result and adjusting model parameters of the first model to generate an optimal model.

On another aspect, said acquiring design requirements of a target wind turbine tower includes:
acquiring the design requirements of the target wind turbine tower, including structural requirements, material requirements, and environmental requirements; and
generating basic structural information of the target wind turbine tower according to the design requirements and combined with international standards.

On another aspect, said establishing a three-dimensional finite element model of the target wind turbine tower includes:
building an overall structure of the tower according to the basic structural information of the target wind turbine tower;
determining designs of tower sections of the tower according to the design requirements, and refining a hierarchical structure based on the overall structure of the tower, and detailing connection manners and specific material requirements between the tower sections to obtain a geometric modeling of the target wind turbine tower; and
determining minimum element precision of mesh division according to geometric complexity and analysis demands of the tower, placing the geometric modeling into a mesh, designing boundary conditions and connections with peripheral equipment, and generating the three-dimensional finite element model of the target wind turbine tower.

On another aspect, said performing linear stress analysis on the three-dimensional finite element model through finite element software includes:
dividing the target wind turbine tower into discrete small elements based on the three-dimensional finite element model; and acquiring specific node information of each structural node in the small elements, and obtaining a stress vector of any node of any small element as:

$$σ = \frac{{E}_{0}}{( 1 + {v}_{0} ) ( 1 - 2 {v}_{0} )} [ \begin{matrix}1 - {v}_{0} & {v}_{0} & {v}_{0} \\ {v}_{0} & 1 - {v}_{0} & {v}_{0} \\ {v}_{0} & {v}_{0} & 1 - {v}_{0}\end{matrix} ] \cdot B \cdot u ;$$

where σ represents the stress vector of the node, E₀ represents a Young's modulus of a material of the node, v₀ represents a Poisson's ratio of the material of the node, B represents a deformation matrix of the small element where the node is located, u represents a displacement vector of the node, and ⋅ represents the dot product.

On another aspect, said identifying fatigue-prone areas includes:
evaluating a fatigue factor of each node according to material mechanics based on the stress vector of the node of the small element, and obtaining a fatigue life of the small element as:

$$N = {\sum }_{i = 1}^{n} \frac{c}{{( \frac{{σ}_{max} ( i ) - {σ}_{min} ( i )}{2} )}^{b}} + {K}_{i} \times {σ}_{n o m} ( i ) ;$$

where N represents the fatigue life of the small element, σₘₐₓ(i) represents a maximum amplitude in the stress vector of an i-th node of the small element, σₘᵢₙ(i) represents a minimum amplitude in the stress vector of the i-th node of the small element, b represents a material constant of the small element, C represents a stress adjustment coefficient of the small element, Kᵢ represents the fatigue factor of the i-th node of the small element, and σₙₒₘ(i) represents a reference stress of the i-th node of the small element;

traversing all small elements of the three-dimensional finite element model, and if the fatigue life of any small element is less than a preset life threshold, determining the small element as a fatigue-prone area and adding a mark to it in the three-dimensional finite element model.

On another aspect, said generating a first model by adjusting prestressed structural parameters of the three-dimensional finite element model and performing iterative optimization until the fatigue-prone areas meet targets of fatigue resistance and safety includes:
constructing constraint conditions according to the fatigue-prone areas, generating fatigue damage coefficients, obtaining convergence targets of optimized fatigue resistance and safety by combining with prestressed structural parameters of the fatigue-prone areas, and constructing an objective function;
constructing a population, where a size of the population is a sum of parameter numbers of the prestressed structural parameters and the fatigue damage coefficients, and any individual in the population represents a set of prestressed structural parameters and fatigue damage coefficients as genes of the individual;
evaluating fitness of any individual in the population as:

R(xⱼ)=D₁×dam(xⱼ)+D₂×vio(xⱼ)+MIN(x); where R(xⱼ) represents the fitness of a j-th individual in the population, D₁ represents a fatigue damage adaptation weight, D₂ represents a stress structural adaptation weight, MIN(x) represents minimum fitness of the individuals in the population, dam(xⱼ) represents a fatigue damage evaluation function of the j-th individual, and vio(xⱼ) represents a prestressed structure evaluation function of the j-th individual;
selecting a plurality of individuals as parents according to a preset parent ratio of the population to generate a parent group, crossing any two parents in the parent group, and exchanging genes with each other in the crossing to generate a new offspring;
calculating fitness of the new offspring, and selecting new parents according to the preset parent ratio;
when the objective function reaches a preset convergence target, terminating the iteration, and selecting the individual with highest fitness as an optimal solution; and
adjusting the three-dimensional finite element model based on the prestressed structural parameters and fatigue damage coefficients under the optimal solution to generate the first model.

On another aspect, said using a fatigue analysis method to predict performance of the first model during a preset service life to obtain a prediction result includes:
constructing an S-N curve of any small element according to fatigue lives and stress magnitudes of different small elements of the first model;
accumulating fatigue damage of all small elements in the first model using the Miner's Rule and combining the S-N curve to obtain total fatigue damage of the target wind turbine tower as:

$$DT = \sum \frac{g k}{N k} ;$$

where DT represents the total fatigue damage, gk represents a load cycle number under a k-th working condition, and Nk represents fatigue lives of all small elements under the k-th working condition; and

if DT≥1, determining that the first model undergoes fatigue failure before the preset service life.

On another aspect, said performing inverse optimization on the first model according to the prediction result and adjusting model parameters of the first model to generate an optimal model includes:
if the load cycle number when the first model undergoes fatigue failure is less than a preset number, determining that a structure of the first model is unreasonable; and determining weak points according to the fatigue lives of all small elements, adjusting prestressed structural parameters and fatigue damage coefficients of the small elements to obtain a new element structure, and generating the optimal model based on the adjusted new element structure; and
if not, determining that the first model is reasonable, and the first model is regarded as the optimal model.

Compared with the prior art, the beneficial effects of the present disclosure are as follows:

The present disclosure provides a wind turbine tower structure optimization method based on finite element analysis, which is used to establish a three-dimensional finite element model of a wind turbine tower, perform linear stress analysis to identify fatigue-prone areas, adjust prestressed structural parameters for iterative optimization to ensure that the fatigue areas meet safety requirements, generate a preliminary model, perform fatigue analysis to predict the performance of the model during a service life, and perform inverse optimization according to a prediction result to adjust the parameters of the model, thereby finally obtaining an optimal wind turbine tower design, which effectively improves the fatigue durability and structural safety of the tower.

### BRIEF DESCRIPTION OF THE DRAWINGS

To make the objectives, technical solutions and advantages of the present disclosure clearer, the technical solutions of the present disclosure will be described clearly and completely below in conjunction with the accompanying drawings of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

FIG. 1 is a schematic flow diagram of a wind turbine tower structure optimization method based on finite element analysis according to an embodiment of the present disclosure.

### DETAILED DESCRIPTION OF THE EMBODIMENTS

To make the objectives, technical solutions and advantages of the present disclosure clearer, the technical solutions of the present disclosure will be described clearly and completely below in conjunction with the accompanying drawings of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

### Embodiment 1

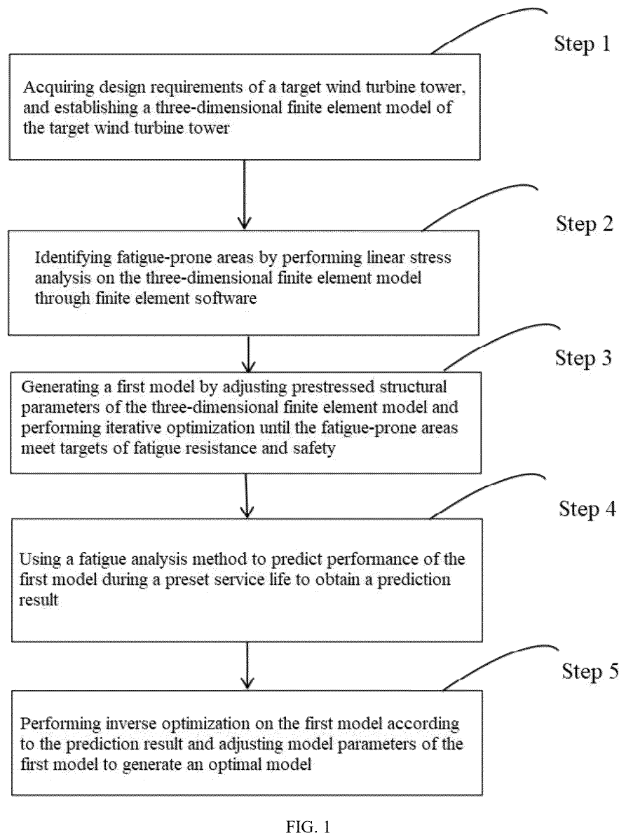

As shown in FIG. 1, a wind turbine tower structure optimization method based on finite element analysis according to an embodiment of the present disclosure includes:
Step 1: acquiring design requirements of a target wind turbine tower, and establishing a three-dimensional finite element model of the target wind turbine tower;
Step 2: identifying fatigue-prone areas by performing linear stress analysis on the three-dimensional finite element model through finite element software;
Step 3: generating a first model by adjusting prestressed structural parameters of the three-dimensional finite element model and performing iterative optimization until the fatigue-prone areas meet targets of fatigue resistance and safety;
Step 4: using a fatigue analysis method to predict performance of the first model during a preset service life to obtain a prediction result; and
Step 5: performing inverse optimization on the first model according to the prediction result and adjusting model parameters of the first model to generate an optimal model.

In this embodiment, the target wind turbine tower refers to a tower structure specially designed for a wind power generating set according to design requirements and engineering demands.

In this embodiment, the design requirements refer to specific requirements formulated for the functional demands, performance standards, technical specifications, and safety standards of the target wind turbine tower, including: bearing capacity, fatigue durability, material requirements, etc.

In this embodiment, the three-dimensional finite element model is a three-dimensional digital representation for performing numerical simulation on the target structure by means of the finite element method.

In this embodiment, the finite element software is a computer software tool for finite element analysis, which is used to simulate and analyze the behaviors of complex structures, mechanical components, heat conduction, electromagnetic fields and other physical problems.

In this embodiment, the linear stress analysis is used to analyze the stress, strain, and deformation of materials or structures under an external force.

In this embodiment, the fatigue-prone areas refer to those places that are prone to local stress concentration and deformation under a repeated load.

In this embodiment, the prestressed structural parameters refer to the parameters intentionally applied to a structure during the structural design, including: prestress magnitude, prestress distribution, prestress type, etc.

In this embodiment, the first model refers to a preliminary optimized model of the wind turbine tower obtained through the following process.

In this embodiment, the fatigue analysis method is an analysis technology for evaluating potential fatigue damage of a structure under the action of multiple cyclic loads.

In this embodiment, the preset service life refers to an expected service period set by a designer based on the actual service environment and requirements of a structure during the design process of the wind turbine tower.

In this embodiment, the prediction result refers to an expected result obtained by the fatigue analysis method on potential fatigue damage, performance degradation or structural failure of the target wind turbine tower during the preset service life.

In this embodiment, the model parameters refer to various values and variables used to define and describe the tower's structure characteristics, load conditions and material behaviors during the design and optimization of the wind turbine tower, including prestressed structural parameters, material parameters, load parameters, etc.

In this embodiment, the optimal model refers to the finally obtained wind turbine tower model through multiple inverse iterative optimization steps during the optimization process of the wind turbine tower.

The working principle and beneficial effects of the above technical solution are: by establishing the three-dimensional finite element model of the wind turbine tower, performing linear stress and fatigue analysis, optimizing prestressed structural parameters, and performing iterative optimization to improve fatigue resistance, the optimal model is finally generated to ensure the safety and performance of the tower during its service life.

### Embodiment 2

On the basis of the above Embodiment 1, said acquiring design requirements of a target wind turbine tower includes:
acquiring the design requirements of the target wind turbine tower, including structural requirements, material requirements, and environmental requirements; and
generating basic structural information of the target wind turbine tower according to the design requirements and combined with international standards.

In this embodiment, the structural requirements include: bearing capacity, stability, fatigue resistance, etc.

In this embodiment, the material requirements include: strength requirements, corrosion resistance, fatigue resistance, etc.

In this embodiment, the environmental requirements include: temperature conditions, wind speed, humidity, etc.

In this embodiment, the basic structural information includes: materials, tower structure, surface treatment technology, etc.

The working principle and beneficial effects of the above technical solution are: by analyzing the design requirements of the target wind turbine tower and combined with international standards, the basic structural information is generated, ensuring that the tower meets the standards of safety, reliability and performance on the basis of meeting structural, material and environmental requirements, and optimizing the design process and improving the adaptability of the wind turbine tower.

### Embodiment 3

On the basis of the above Embodiment 2, said establishing a three-dimensional finite element model of the target wind turbine tower includes:
building an overall structure of the tower according to the basic structural information of the target wind turbine tower;
determining designs of tower sections of the tower according to the design requirements, and refining a hierarchical structure based on the overall structure of the tower, and detailing connection manners and specific material requirements between the tower sections to obtain a geometric modeling of the target wind turbine tower; and
determining minimum element precision of mesh division according to geometric complexity and analysis demands of the tower, placing the geometric modeling into a mesh, designing boundary conditions and connections with peripheral equipment, and generating the three-dimensional finite element model of the target wind turbine tower.

In this embodiment, the overall structure of the tower is the basic structure of the tower.

In this embodiment, the tower sections are segmented units in the overall structure of the wind turbine tower, and each section represents an independent part of the tower.

In this embodiment, the hierarchical structure refers to the design requirements of the tower sections and the connection manners therebetween according to the overall structural function of the tower.

In this embodiment, the connection manners include: bolt connection, welding, riveting, etc.

In this embodiment, the geometric modeling refers to the process of creating the geometric shape of an object through computer-aided design (CAD) or other modeling tools.

In this embodiment, the minimum element refers to the smallest basic unit used to discretize a structure during mesh division.

In this embodiment, the mesh in engineering calculation refers to dividing a complex geometric model into multiple small elements or units, thereby converting a continuous physical problem into a discrete calculation problem.

In this embodiment, the boundary conditions refer to the constraints and loading conditions applied in the model, such as displacement boundary conditions, mechanical boundary conditions, symmetric boundary conditions, etc.

The working principle and beneficial effects of the above technical solution are: by building the overall structure of the tower and refining the tower section design, clarifying the connection manners and material requirements, the geometric model is generated. Through accurate mesh division and boundary condition design, the three-dimensional finite element model is constructed, which improves the precision and reliability of tower analysis and provides a solid foundation for subsequent optimization.

### Embodiment 4

On the basis of the above Embodiment 1, said performing linear stress analysis on the three-dimensional finite element model through finite element software includes:
dividing the target wind turbine tower into discrete small elements based on the three-dimensional finite element model; and acquiring specific node information of each structural node in the small elements, and obtaining a stress vector of any node of any small element as:

$$σ = \frac{{E}_{0}}{( 1 + {v}_{0} ) ( 1 - 2 {v}_{0} )} [ \begin{matrix}1 - {v}_{0} & {v}_{0} & {v}_{0} \\ {v}_{0} & 1 - {v}_{0} & {v}_{0} \\ {v}_{0} & {v}_{0} & 1 - {v}_{0}\end{matrix} ] \cdot B \cdot u ;$$

where σ represents the stress vector of the node, E₀ represents a Young's modulus of a material of the node, v₀ represents a Poisson's ratio of the material of the node, B represents a deformation matrix of the small element where the node is located, u represents a displacement vector of the node, and ⋅ represents the dot product.

In this embodiment, the small element refers to each small and independent calculation element obtained after dividing a large structure into multiple discrete areas.

In this embodiment, the structural node refers to a key point of each small element in the discretized model, which represents a position in physical space, and is a place for calculating and storing physical quantities such as stress, strain and displacement.

In this embodiment, the specific node information includes: node coordinates, node degrees of freedom, material properties, etc.

In this embodiment, the stress vector is a physical quantity describing the internal force state at a node inside the material caused by an external force, a temperature change, constraints and other factors.

In this embodiment, the Young's modulus is used to describe the stiffness of the material under an external force such as tension or compression.

In this embodiment, the Poisson's ratio is a physical quantity describing the relationship between a transverse strain and a longitudinal strain of the material when it is deformed.

The working principle and beneficial effects of the above technical solution are: by dividing the target wind turbine tower into discrete small elements, acquiring the stress vector of each node, and combining Young's modulus, Poisson's ratio, deformation matrix and displacement vector to perform stress analysis, the precision of the model is improved, assisting in evaluating the mechanical performance and safety of the tower structure.

### Embodiment 5

On the basis of the above Embodiment 4, said identifying fatigue-prone areas includes:
evaluating a fatigue factor of each node according to material mechanics based on the stress vector of the node of the small element, and obtaining a fatigue life of the small element as:

$$N = {\sum }_{i = 1}^{n} \frac{c}{{( \frac{{σ}_{max} ( i ) - {σ}_{min} ( i )}{2} )}^{b}} + {K}_{i} \times {σ}_{n o m} ( i ) ;$$

where N represents the fatigue life of the small element, σₘₐₓ(i) represents a maximum amplitude in the stress vector of an i-th node of the small element, σₘᵢₙ(i) represents a minimum amplitude in the stress vector of the i-th node of the small element, b represents a material constant of the small element, C represents a stress adjustment coefficient of the small element, Kᵢ represents the fatigue factor of the i-th node of the small element, and σₙₒₘ(i) represents a reference stress of the i-th node of the small element;
traversing all small elements of the three-dimensional finite element model, and if the fatigue life of any small element is less than a preset life threshold, determining the small element as a fatigue-prone area and adding a mark to it in the three-dimensional finite element model.

In this embodiment, the material mechanics is a discipline that studies the deformation and stress distribution laws of a solid material under the action of an external force.

In this embodiment, the fatigue factor is a parameter measured based on the fatigue strength, stress level and stress cycle mode of a material.

In this embodiment, the fatigue life refers to the number of load cycles that a material or structure can withstand before fatigue failure occurs under a certain loading condition.

In this embodiment, the preset life threshold refers to a specific value set to judge whether a small element has fatigue risk in the fatigue life evaluation.

The working principle and beneficial effects of the above technical solution are: by evaluating the fatigue factor of each node and calculating the fatigue life of the small element according to the stress amplitude, and traversing the model, the fatigue-prone areas are identified. By marking the fatigue-prone areas, it assists in optimizing the design and improving the durability and safety of the tower.

### Embodiment 6

On the basis of the above Embodiment 5, said generating a first model by adjusting prestressed structural parameters of the three-dimensional finite element model and performing iterative optimization until the fatigue-prone areas meet targets of fatigue resistance and safety includes:
constructing constraint conditions according to the fatigue-prone areas, generating fatigue damage coefficients, obtaining convergence targets of optimized fatigue resistance and safety by combining with prestressed structural parameters of the fatigue-prone areas, and constructing an objective function;
constructing a population, wherein a size of the population is a sum of parameter numbers of the prestressed structural parameters and the fatigue damage coefficients, and any individual in the population represents a set of prestressed structural parameters and fatigue damage coefficients as genes of the individual;
evaluating fitness of any individual in the population as:
R(xⱼ)=D₁×dam(xⱼ)+D₂×vio(xⱼ)+MIN(x); where R(xⱼ) represents the fitness of a j-th individual in the population, D₁ represents a fatigue damage adaptation weight, D₂ represents a stress structural adaptation weight, MIN(x) represents minimum fitness of the individuals in the population, dam(xⱼ) represents a fatigue damage evaluation function of the j-th individual, and vio(xⱼ) represents a prestressed structure evaluation function of the j-th individual;
selecting a plurality of individuals as parents according to a preset parent ratio of the population to generate a parent group, crossing any two parents in the parent group, and exchanging genes with each other in the crossing to generate a new offspring;
calculating fitness of the new offspring, and selecting new parents according to the preset parent ratio;
when the objective function reaches a preset convergence target, terminating the iteration, and selecting the individual with highest fitness as an optimal solution; and
adjusting the three-dimensional finite element model based on the prestressed structural parameters and fatigue damage coefficients under the optimal solution to generate the first model.

In this embodiment, the fatigue damage coefficient is a quantitative index for measuring the damage degree of a structure or material under cyclic load action.

In this embodiment, the convergence target refers to the optimal state that the objective function reaches the preset through the iterative optimization process.

In this embodiment, the objective function is a function comprehensively considering fatigue damage and structural stress, aiming to minimize fatigue damage and optimize the fatigue resistance and safety of a structure.

In this embodiment, the population refers to a group of individuals (solutions) used to simulate the evolutionary process, and each individual represents a set of specific prestressed structural parameters and fatigue damage coefficients.

In this embodiment, the gene refers to the component parts of each individual in the population.

In this embodiment, the fitness is an index used to measure the performance of an individual in a certain problem in the genetic algorithm.

In this embodiment, the preset parent ratio refers to a ratio used to select parent individuals from the current population in the genetic algorithm or evolutionary algorithm.

In this embodiment, the parent refers to an individual selected from the population for breeding the next generation.

In this embodiment, the crossing is an operation simulating a natural biological reproduction process, which generates new individuals (offspring) by exchanging the genetic information of two parent individuals.

In this embodiment, the new offspring refers to the next generation individuals generated through the crossing operation.

In this embodiment, the optimal solution refers to a set of parameters finally found through iteration and selection in the optimization process, so that the value of the constructed objective function reaches the preset convergence target.

The working principle and beneficial effects of the above technical solution are: by optimizing the fatigue damage coefficients and prestressed structural parameters, combining with the genetic algorithm to iteratively select the optimal solution, the fatigue resistance and safety are improved. By constructing the objective function and fitness evaluation, the efficiency and precision of design optimization are improved, which helps to extend the structural life.

### Embodiment 7

On the basis of the above Embodiment 1, said using a fatigue analysis method to predict performance of the first model during a preset service life to obtain a prediction result includes:
constructing an S-N curve of any small element according to fatigue lives and stress magnitudes of different small elements of the first model;
accumulating fatigue damage of all small elements in the first model using the Miner's Rule and combining the S-N curve to obtain total fatigue damage of the target wind turbine tower as:

$$DT = \sum \frac{g k}{N k} ;$$

where DT represents the total fatigue damage, gk represents a load cycle number under a k-th working condition, and Nk represents fatigue lives of all small elements under the k-th working condition; and
if DT≥1, determining that the first model undergoes fatigue failure before the preset service life.

In this embodiment, the S-N curve is a graphical representation used to describe the fatigue life of a material under different stress levels, describing the number of cycles (N) that a material can withstand until fatigue failure occurs under different stress amplitudes(S).

In this embodiment, the Miner's Rule is a method used to evaluate the cumulative fatigue damage of a material or structure under multiple load conditions. Under multiple working conditions, different load cycles borne by the structure will lead to different degrees of fatigue damage. The core idea of the Miner's Rule is to accumulate the damage under each load condition in proportion to finally judge the overall fatigue life of the structure or material.

In this embodiment, the fatigue damage refers to the progressive damage generated in a material or structure after undergoing multiple cyclic loadings under the action of repeated loads.

In this embodiment, the fatigue failure refers to a phenomenon that causes the structural performance degradation or failure due to the initiation, propagation and final fracture of microcracks in the material or structure after a period of time after bearing cyclic loads or under the action of repeated loads.

The working principle and beneficial effects of the above technical solution are: by constructing the S-N curve and applying the Miner's Rule, and comprehensively considering the fatigue damage of small elements under different working conditions, the overall fatigue life of the wind turbine tower is accurately evaluated. It can be effectively judged whether the tower will undergo fatigue failure within the preset service life, improving the structural reliability and safety.

### Embodiment 8

On the basis of the above Embodiment 7, said performing inverse optimization on the first model according to the prediction result and adjusting model parameters of the first model to generate an optimal model includes:
if the load cycle number when the first model undergoes fatigue failure is less than a preset number, determining that a structure of the first model is unreasonable; and determining weak points according to the fatigue lives of all small elements, adjusting prestressed structural parameters and fatigue damage coefficients of the small elements to obtain a new element structure, and generating the optimal model based on the adjusted new element structure; and
if not, determining that the first model is reasonable, and the first model is regarded as the optimal model.

In this embodiment, the preset number refers to an upper limit of the number of cyclic load cycles set during the design process.

In this embodiment, the load cycle number refers to the number of times a material or structure bears the action of repeated loads (i.e., periodic loads) during a fatigue test or actual use.

The working principle and beneficial effects of the above technical solution are: by judging whether the load cycle number when fatigue failure occurs is less than a preset value, the weak points of the structure are identified, and the prestressed structural parameters and fatigue damage coefficients are adjusted to optimize the element structure, and finally the optimal model is generated, improving the reliability and service life of the structure.

Finally, it should be noted that the above embodiments are only used to illustrate the technical solutions of the present disclosure, but not to limit the present disclosure; although the present disclosure has been described in detail with reference to the foregoing embodiments, those of skill in the art should understand that they can still modify the technical solutions recited in the foregoing embodiments, or equivalently replace some technical features therein; and these modifications or replacements do not make the essence of the corresponding technical solutions deviate from the spirit and scope of the technical solutions of the embodiments of the present disclosure.

What is claimed is:

1. A wind turbine tower structure optimization method based on finite element analysis, comprising:
Step 1: acquiring design requirements of a target wind turbine tower, and establishing a three-dimensional finite element model of the target wind turbine tower;
Step 2: identifying fatigue-prone areas by performing linear stress analysis on the three-dimensional finite element model through finite element software;
Step 3: generating a first model by adjusting prestressed structural parameters of the three-dimensional finite element model and performing iterative optimization until the fatigue-prone areas meet targets of fatigue resistance and safety;
Step 4: using a fatigue analysis method to predict performance of the first model during a preset service life to obtain a prediction result; and
Step 5: performing inverse optimization on the first model according to the prediction result and adjusting model parameters of the first model to generate an optimal model,
wherein said using a fatigue analysis method to predict performance of the first model during a preset service life to obtain a prediction result comprises:
constructing an S-N curve of any small element according to fatigue lives and stress magnitudes of different small elements of the first model;
accumulating fatigue damage of all small elements in the first model using the Miner's Rule and combining the S-N curve to obtain total fatigue damage of the target wind turbine tower as:
$$DT = \sum \frac{g k}{N k} ;$$
where DT represents the total fatigue damage, gk represents a load cycle number under a k-th working condition, and Nk represents fatigue lives of all small elements under the k-th working condition; and
if DT≥1, determining that the first model undergoes fatigue failure before the preset service life,
said performing inverse optimization on the first model according to the prediction result and adjusting model parameters of the first model to generate an optimal model comprises:
if the load cycle number when the first model undergoes fatigue failure is less than a preset number, determining that a structure of the first model is unreasonable; and determining weak points according to the fatigue lives of all small elements, adjusting prestressed structural parameters and fatigue damage coefficients of the small elements to obtain a new element structure, and generating the optimal model based on the adjusted new element structure; and
if not, determining that the first model is reasonable, and the first model is regarded as the optimal model.

2. The wind turbine tower structure optimization method based on finite element analysis according to claim 1, wherein said acquiring design requirements of a target wind turbine tower comprises:
acquiring the design requirements of the target wind turbine tower, comprising structural requirements, material requirements, and environmental requirements; and
generating basic structural information of the target wind turbine tower according to the design requirements and combined with international standards.

3. The wind turbine tower structure optimization method based on finite element analysis according to claim 2, wherein said establishing a three-dimensional finite element model of the target wind turbine tower comprises:
building an overall structure of the tower according to the basic structural information of the target wind turbine tower;
determining designs of tower sections of the tower according to the design requirements, and refining a hierarchical structure based on the overall structure of the tower, and detailing connection manners and specific material requirements between the tower sections to obtain a geometric modeling of the target wind turbine tower; and
determining minimum element precision of mesh division according to geometric complexity and analysis demands of the tower, placing the geometric modeling into a mesh, designing boundary conditions and connections with peripheral equipment, and generating the three-dimensional finite element model of the target wind turbine tower.

4. The wind turbine tower structure optimization method based on finite element analysis according to claim 1, wherein said performing linear stress analysis on the three-dimensional finite element model through finite element software comprises:
dividing the target wind turbine tower into discrete small elements based on the three-dimensional finite element model; and acquiring specific node information of each structural node in the small elements, and obtaining a stress vector of any node of any small element as:
$$σ = \frac{{E}_{0}}{( 1 + {v}_{0} ) ( 1 - 2 {v}_{0} )} [ \begin{matrix}1 - {v}_{0} & {v}_{0} & {v}_{0} \\ {v}_{0} & 1 - {v}_{0} & {v}_{0} \\ {v}_{0} & {v}_{0} & 1 - {v}_{0}\end{matrix} ] \cdot B \cdot u ;$$
where σ represents the stress vector of the node, E₀ represents a Young's modulus of a material of the node, v₀ represents a Poisson's ratio of the material of the node, B represents a deformation matrix of the small element where the node is located, u represents a displacement vector of the node, and ⋅ represents the dot product.

5. The wind turbine tower structure optimization method based on finite element analysis according to claim 4, wherein said identifying fatigue-prone areas comprises:
evaluating a fatigue factor of each node according to material mechanics based on the stress vector of the node of the small element, and obtaining the fatigue life of the small element as:
$$N = {\sum }_{i = 1}^{n} \frac{c}{{( \frac{{σ}_{max} ( i ) - {σ}_{min} ( i )}{2} )}^{b}} + {K}_{i} \times {σ}_{n o m ( i )} ;$$
where N represents the fatigue life of the small element, σₘₐₓ(i) represents a maximum amplitude in the stress vector of an i-th node of the small element, σₘᵢₙ(i) represents a minimum amplitude in the stress vector of the i-th node of the small element, b represents a material constant of the small element, C represents a stress adjustment coefficient of the small element, Kᵢ represents the fatigue factor of the i-th node of the small element, and σₙₒₘ(i) represents a reference stress of the i-th node of the small element;
traversing all small elements of the three-dimensional finite element model, and if the fatigue life of any small element is less than a preset life threshold, determining the small element as a fatigue-prone area and adding a mark to it in the three-dimensional finite element model.

6. The wind turbine tower structure optimization method based on finite element analysis according to claim 5, wherein said generating a first model by adjusting prestressed structural parameters of the three-dimensional finite element model and performing iterative optimization until the fatigue-prone areas meet targets of fatigue resistance and safety comprises:
constructing constraint conditions according to the fatigue-prone areas, generating fatigue damage coefficients, obtaining convergence targets of optimized fatigue resistance and safety by combining with prestressed structural parameters of the fatigue-prone areas, and constructing an objective function;
constructing a population, wherein a size of the population is a sum of parameter numbers of the prestressed structural parameters and the fatigue damage coefficients, and any individual in the population represents a set of prestressed structural parameters and fatigue damage coefficients as genes of the individual;
evaluating fitness of any individual in the population as:
R(xⱼ)=D₁×dam(xⱼ)+D₂×vio(xⱼ)+MIN(x); where R(xⱼ) represents the fitness of a j-th individual in the population, D₁ represents a fatigue damage adaptation weight, D₂ represents a stress structural adaptation weight, MIN(x) represents minimum fitness of the individuals in the population, dam(xⱼ) represents a fatigue damage evaluation function of the j-th individual, and vio(xⱼ) represents a prestressed structure evaluation function of the j-th individual;
selecting a plurality of individuals as parents according to a preset parent ratio of the population to generate a parent group, crossing any two parents in the parent group, and exchanging genes with each other in the crossing to generate a new offspring;
calculating fitness of the new offspring, and selecting new parents according to the preset parent ratio;
when the objective function reaches a preset convergence target, terminating the iteration, and selecting the individual with highest fitness as an optimal solution; and
adjusting the three-dimensional finite element model based on the prestressed structural parameters and fatigue damage coefficients under the optimal solution to generate the first model.
